(19) United States
(12) Patent Application Publication
(10) Pub. No.: US 2007/0217374 A1
(43) Pub. Date: Sep. 20, 2007

(54) Techniques to collaborate wireless terminal position location information from multiple wireless networks

(76) Inventor: Shay Waxman, Haifa (IL)

Correspondence Address: INTEL CORPORATION;c/o INTELLEVATE, LLC, P.O. BOX 52050, MINNEAPOLIS, MN, 55402, US

(21) Appl. No.: 11/377,707

(22) Filed: Mar. 15, 2006

(51) Int. Cl. H04Q 7/24

(52) U.S. Cl. 370/338

(57) ABSTRACT

An embodiment of the present invention provides an apparatus, comprising a wireless terminal operable in a wireless local area network (WLAN) and a wireless metropolitan area network (WMAN), wherein the wireless terminal is capable of collaborating terminal position information in the WMAN and terminal position information in the WLAN to determine the position of the wireless terminal.

### BACKGROUND

Wireless networks have grown increasingly in importance and have varying uses. In addition to communications, it is useful to provide position information in wireless networks. Distinct wireless networks may utilize distinct position location determination techniques, each of which may be advantageous and more effective in various usage scenarios.

Thus, a strong need exists for techniques to collaborate wireless terminal position locations determined from various wireless networks which use various position determination techniques.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the determination of position location of a combination WMAN-WLAN terminal of an embodiment of the present invention; and

FIG. 2 illustrates a method according to one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An embodiment of the present invention provides wireless metropolitan area network (WMAN) such as, but not limited to, cellular or WiMAX, position location of combination WMAN-WLAN wireless terminals, even in cases where GPS does not exist or does not operate properly. This may be the case when operating indoors or when multiple base-stations are not around for spotting the device or simply due to poor accuracy of the WMAN position location. In an embodiment of the present invention, higher layer protocols such as mobile IP etc. are not required for locating the device through a wireless local area network (WLAN) and in addition, WLAN nodes, such as a wireless terminal as referred to herein, does not have to be associated or need to transmit.

Wireless local area network (WLAN) access points (APs) may be capable of storing and broadcasting their location based on GPS or manual settings or setting through networks, to name a few. In an embodiment of the present invention, a wireless metropolitan area network (WMAN), such as, but not limited to cellular or WiMAX, may locate a wireless terminal of the present invention based on the information the wireless terminal obtains from a WLAN AP which may be derived from one or more APs that store their location information; although the present invention is not limited in this respect.

In an embodiment of the present invention, one method for the wireless terminal to estimate its position would be to store the coordinates of the AP it is associated to or in another embodiment of the present invention, the AP received with the highest RSSI.

If more than one AP is received, a more complicated but accurate scheme may be to use algorithms that try to better estimate the coordinates of the mobile WLAN terminal, based on information from these multiple WLAN AP's (these algorithms are well known to those or ordinary skill in the art for implementation into an embodiment the present invention). In an embodiment of the present invention, the WLAN AP may broadcast its position using a beacon packet. In such case, the wireless terminal does not have to be associated to the WLAN AP in order to properly receive the position of the AP. An embodiment of the present invention provides a single radio frequency (RF) chain with a dual WMAN-WLAN mode, wherein during WLAN operation, the location may be stored and during WMAN operation the location may be reported.

The position location method proposed in an embodiment herein may be used in cases where GPS does not function properly due to indoor usage or multiple base-stations are not around to spot the wireless terminal or simply due to insufficient accuracy of the WMAN position location. An embodiment of the present invention may provide that locating a wireless terminal through the WLAN network may also possible but may require a more complicated bi-directional protocol such as mobile IP; and the wireless terminal must transmit and this may not be possible if the wireless terminal is not associated as proposed in an embodiment of the present invention.

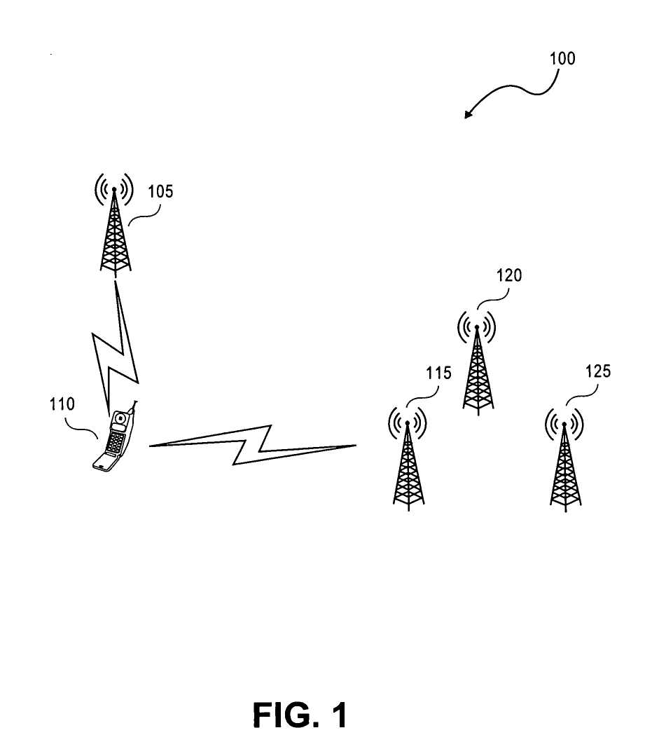

Turning now to the figures, FIG. 1, shown generally as 100, illustrates the determination of position location of combination WMAN-WLAN terminal of an embodiment of the present invention. The WMAN-WLAN combination wireless terminal is shown at 110 evaluating its positing from WLAN APs position information and other parameters such as RSSI and the like. WLAN APs 115, 120 and 125 may broadcast their position information to wireless terminal 110. Wireless terminal 110 may further be in communication with WWAN base station 105, wherein WWAN base station 15 may be trying to position locate a WMAN node (i.e., wireless terminal 110). This position information may be provided to WMAN base station 105 by wireless terminal 110 which may have been obtained from at least one of said WLAN APs 115, 120 or 125.

FIG. 1 also may depict a system of an embodiment of the present invention, which comprises a wireless terminal 110, at least one access point (AP), 115, 120 and 125 in a wireless local area network capable of communication with the wireless terminal 110 and providing wireless terminal position information, a base station 105 in a wireless metropolitan area network capable of communicating with the wireless terminal 110 and providing wireless terminal position information, and wherein the wireless terminal 110 is capable of collaborating wireless terminal 110 position information in the WMAN and wireless terminal position information in the WLAN to determine the position of the wireless terminal 110.

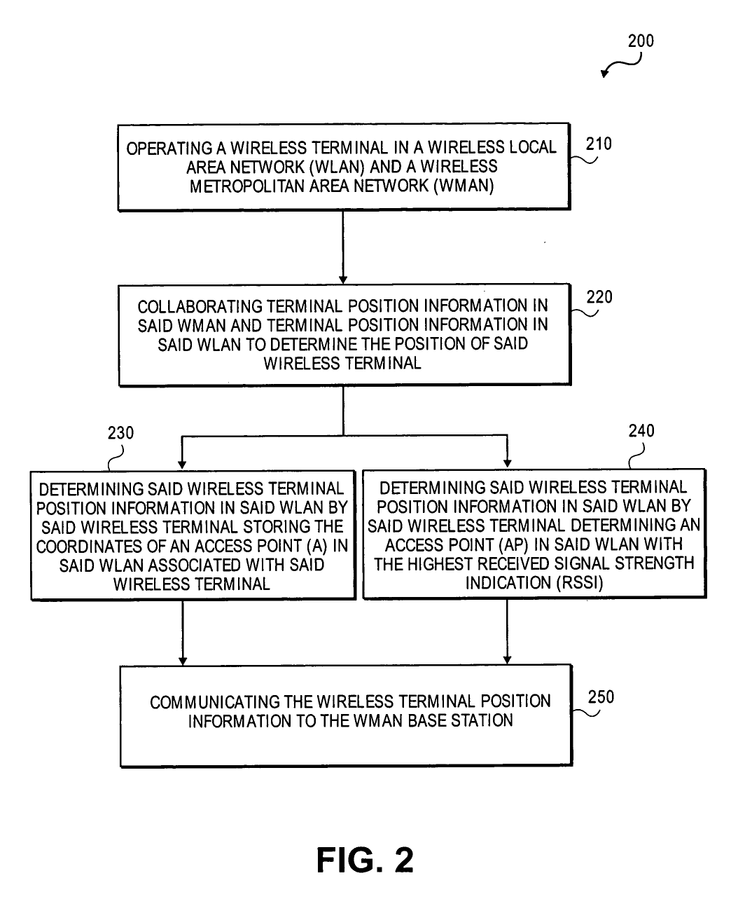

Turning now to FIG. 2, at 200, is a method according to an embodiment of the present invention. An embodiment of the present method may comprise operating a wireless terminal in a wireless local area network (WLAN) and a wireless metropolitan area network (WMAN) 210 and collaborating terminal position information in the WMAN and terminal position information in the WLAN to determine the position of the wireless terminal 220. The present method may further comprise determining the wireless terminal position information in the WLAN by the wireless terminal storing the coordinates of an access point (A) in the WLAN associated with the wireless terminal 230 or determining the wireless terminal position information in the WLAN by the wireless terminal determining an access point (AP) in the WLAN with the highest received signal strength indication (RSSI) 240. In an embodiment of the present invention, the present method may further comprise communicating the wireless terminal position information to the WMAN base station 250.

Yet another embodiment of the present invention provides a machine-accessible medium that provides instructions, which when accessed, cause a machine to perform operations comprising, controlling the operations of a wireless terminal in a wireless local area network (WLAN) and a wireless metropolitan area network (WMAN) and collaborating terminal position information in the WMAN and terminal position information in the WLAN to determine the position of the wireless terminal. The machine-accessible medium of an embodiment of the present invention may further comprise the instructions causing the machine to perform operations further comprising determining the wireless terminal position information in the WLAN by the wireless terminal storing the coordinates of an access point (A) in the WLAN associated with the wireless terminal and may also further comprise the instructions causing the machine to perform operations further comprising determining the wireless terminal position information in the WLAN by the wireless terminal determining an access point (AP) in the WLAN with the highest received signal strength indication (RSSI).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a wireless terminal operable in a wireless local area network (WLAN) and a wireless metropolitan area network (WMAN), wherein said wireless terminal is capable of collaborating terminal position information in said WMAN and terminal position information in said WLAN to determine the position of said wireless terminal.

2. The apparatus of claim 1, wherein said wireless terminal position information in said WLAN is determined by said wireless terminal storing the coordinates of an access point (A) in said WLAN associated with said wireless terminal.

3. The apparatus of claim 1, wherein said wireless terminal position information in said WLAN is determined by said wireless terminal determining an access point (AP) in said WLAN with the highest received signal strength indication (RSSI).

4. The apparatus of claim 3, wherein said wireless terminal position information in said WLAN is determined by said wireless terminal communicating with a plurality of APs in said WLAN and calculating said wireless terminal's position information based upon information derived from said plurality of APs.

5. The apparatus of claim 1, wherein said wireless terminal position information in said WLAN is determined by a WLAN AP broadcasting its position using a beacon packet.

6. The apparatus of claim 1, wherein during WLAN operation said WLAN terminal position information is stored in said wireless terminal and during WMAN operation the location is reported by said wireless terminal.

7. The apparatus of claim 6, wherein said wireless terminal position information within said WMAN is determined by a global positioning system position associated with said WMAN.

8. A method, comprising:
operating a wireless terminal in a wireless local area network (WLAN) and a wireless metropolitan area network (WMAN) and collaborating terminal position information in said WMAN and terminal position information in said WLAN to determine the position of said wireless terminal.

9. The method of claim 8, further comprising determining said wireless terminal position information in said WLAN by said wireless terminal storing the coordinates of an access point (A) in said WLAN associated with said wireless terminal.

10. The method of claim 8, further comprising determining said wireless terminal position information in said WLAN by said wireless terminal determining an access point (AP) in said WLAN with the highest received signal strength indication (RSSI).

11. The method of claim 10, further comprising determining said wireless terminal position information in said WLAN by said wireless terminal communicating with a plurality of APs in said WLAN and calculating said wireless terminal's position information based upon information derived from said plurality of APs.

12. The method of claim 8, further comprising determining said wireless terminal position information in said WLAN by a WLAN AP broadcasting its position using a beacon packet.

13. The method of claim 8, further comprising storing in said wireless terminal during WLAN operation said WLAN terminal position information and during WMAN operation said location is reported by said wireless terminal.

14. The method of claim 13, further comprising determining said wireless terminal position information within said WMAN by a global positioning system position associated with said WMAN.

15. A machine-accessible medium that provides instructions, which when accessed, cause a machine to perform operations comprising:
controlling the operations of a wireless terminal in a wireless local area network (WLAN) and a wireless metropolitan area network (WMAN) and collaborating terminal position information in said WMAN and terminal position information in said WLAN to determine the position of said wireless terminal.

16. The machine-accessible medium of claim 15, further comprising said instructions causing said machine to perform operations further comprising determining said wireless terminal position information in said WLAN by said wireless terminal storing the coordinates of an access point (A) in said WLAN associated with said wireless terminal.

17. The machine-accessible medium of claim 14, further comprising said instructions causing said machine to perform operations further comprising determining said wireless terminal position information in said WLAN by said wireless terminal determining an access point (AP) in said WLAN with the highest received signal strength indication (RSSI).

18. The machine-accessible medium of claim 17, further comprising said instructions causing said machine to perform operations further comprising determining said wireless terminal position information in said WLAN by said wireless terminal communicating with a plurality of APs in said WLAN and calculating said wireless terminal's position information based upon information derived from said plurality of APs.

19. The machine-accessible medium of claim 15, further comprising said instructions causing said machine to perform operations further comprising determining said wireless terminal position information in said WLAN by a WLAN AP broadcasting its position using a beacon packet.

20. The machine-accessible medium of claim 15, further comprising said instructions causing said machine to perform operations further comprising storing in said wireless terminal during WLAN operation said WLAN terminal position information and during WMAN operation said location is reported by said wireless terminal.

21. The machine-accessible medium of claim 20, further comprising said instructions causing said machine to perform operations further comprising determining said wireless terminal position information within said WMAN by a global positioning system position associated with said WMAN.

22. A system, comprising:
a wireless terminal;
at least one access point (AP) in a wireless local area network capable of communication with said wireless terminal and providing wireless terminal position information;
a base station in a wireless metropolitan area network capable of communicating with said wireless terminal and providing wireless terminal position information;
wherein said wireless terminal is capable of collaborating wireless terminal position information in said WMAN and wireless terminal position information in said WLAN to determine the position of said wireless terminal.

23. The system of claim 22, wherein said wireless terminal position information in said WLAN is determined by said wireless terminal storing the coordinates of said at least one access point (A) in said WLAN.

24. The system of claim 22, wherein said wireless terminal position information in said WLAN is determined by said wireless terminal determining an access point (AP) in said WLAN with the highest received signal strength indication (RSSI).

25. The system of claim 24, wherein said wireless terminal position information in said WLAN is determined by said wireless terminal communicating with a plurality of APs in said WLAN and calculating said wireless terminal's position information based upon information derived from said plurality of APs.

26. The system of claim 22, wherein said wireless terminal position information in said WLAN is determined by said at least one AP broadcasting its position using a beacon packet.

27. The system of claim 22, wherein said wireless terminal position information within said WMAN is determined by a global positioning system position associated with said WMAN.
